(19) United States
(12) Patent Application Publication
(10) Pub. No.: US 2026/0013008 A1
(43) Pub. Date: Jan. 8, 2026

(54) RESISTANCE HEATING OF COMPOSITE LAMINATE COATINGS

(71) Applicant: TPI Technology, Inc., Scottsdale, AZ (US)

(72) Inventors: Emre Uçkun, Izmir (TR); Berkay Aydogan, Izmir (TR)

(21) Appl. No.: 18/762,261

(22) Filed: Jul. 2, 2024

(51) Int. Cl. H05B 3/16; B32B 3/08; B32B 5/02; B32B 5/26; B32B 15/14; B32B 15/20; F03D 1/06

(52) U.S. Cl. CPC H05B 3/16; B32B 3/085; B32B 5/02; B32B 5/26; B32B 15/14; B32B 15/20; F03D 1/0675; B32B 2255/06; B32B 2255/205; B32B 2260/023; B32B 2260/046; B32B 2262/101; B32B 2307/202; B32B 2307/304; B32B 2603/00; F05B 2230/40; F05B 2280/6003

(57) ABSTRACT

Devices, systems, and methods of improving heat transfer between a composite wind turbine blade surface are provided to reduce cure time. The system includes copper strips applied adjacent to the composite panel, and at desired locations of the blade (e.g. spar caps to facilitate cure/bonding of adhesive). A coating of conductive (e.g. carbon) paint is applied over the copper strips. When a current is applied to the copper strips(s) a uniform and homogenous layer of heat is generated directly against the composite panel, at the desired location of the blade, without need for wiring or heating via fans/ducts.

### BACKGROUND

Embodiments of the present disclosure relate to devices, systems, and methods of improving manufacturing reliability and efficiency during composite product (e.g. wind turbine blade, and/or automobile or marine/boats body) manufacture. In particular, the devices, systems, and methods of the present disclosure relate to carbon based coating systems for resistance heating of composite structures which reduce manufacture cycle time and facilitate the resin/adhesive bond integrity. Additionally, the coating system disclosed herein provides shielding of electromagnetic fields and directly heating a composite surface during a manufacturing process.

### BRIEF SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes an apparatus for heating a composite product comprising: a thermal isolation layer, the thermal isolation layer having a pair of opposing sides, and a top surface and bottom surface defining a thickness therebetween; a composite panel, the composite panel having a pair of opposing sides, and a top surface and bottom surface defining a thickness therebetween; a first conductive strip, the first conductive strip having a pair of opposing sides, and a top surface and bottom surface defining a thickness therebetween; a second conductive strip, the second conductive strip having a pair of opposing sides, and a top surface and bottom surface defining a thickness therebetween; the first and second conductive strips spaced apart by a first distance; at least one layer of conductive paint, the at least one layer of conductive paint disposed over the first and second conductive strips; a protection layer, the protection layer having a pair of opposing sides, and a top surface and bottom surface defining a thickness therebetween.

In some embodiments, the composite product is a wind turbine blade. In some embodiments, the first and second conductive strips are composed of copper tape. In some embodiments, the at least one layer of conductive paint includes a copper paint. In some embodiments, the composite panel is disposed on the top surface of the thermal isolation layer. In some embodiments, the first and second conductive strips disposed on the top surface of the composite panel. In some embodiments, the at least one layer of conductive paint is disposed on the top surface of the first and second conductive strips. In some embodiments, the protection layer is disposed on a top surface of the at least one layer of conductive paint. In some embodiments, the first and second conductive strips are configured in a parallel configuration. In some embodiments, the apparatus further comprises a cart including a power source, the cart configured to transport the thermal isolation layer, composite panel, first and second conductive strips, at least one layer of conductive paint and the protection layer along an exterior of a wind turbine blade.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE SEVERAL VIEWS OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 illustrates an exemplary wind turbine blade which can be formed in accordance with the present disclosure.

FIG. 2 illustrates a top view of an isolated wind turbine blade of FIG. 1.

FIGS. 3A-C illustrate cross sectional views of a blade formed within a mold with a plurality of shear webs, formed according to embodiments of the present disclosure.

FIG. 4 illustrates an exemplary device for heating a composite segment of a wind turbine blade according to embodiments of the present disclosure.

FIG. 5 is a cross sectional view of the exemplary device of FIG. 4.

FIGS. 6-8 are schematic representations of the electrical circuitry of the present disclosure.

FIGS. 9A-B illustrate a front view of an exemplary device for heating a composite segment of a wind turbine blade according to embodiments of the present disclosure; and a zoom-in view thereof, respectively.

FIG. 9C illustrates a zoom-in view of an exemplary device for heating a composite segment of a wind turbine blade according to embodiments of the present disclosure.

FIGS. 10A-B illustrate views of an exemplary device for heating a composite segment of a wind turbine blade according to embodiments of the present disclosure.

FIGS. 11A-E illustrate views of an exemplary device for heating a composite segment of a wind turbine blade according to embodiments of the present disclosure.

FIG. 12 illustrates a diagram of the manufacturing process for a device for holding a gantry according to embodiments of the present disclosure.

FIG. 13 is a graph of stiffness measurements of materials heated in a composite segment of a wind turbine blade as function of time according to embodiments of the present disclosure.

FIG. 14 is an illustration of a penetrometer for measuring the stiffness measurements of materials heated in a composite segment of a wind turbine blade according to embodiments of the present disclosure.

FIG. 15 is an illustration of a stiffness measurement measured with a penetrometer according to embodiments of the present disclosure.

FIG. 16 is an illustration of a stiffness measurement measured with a penetrometer according to embodiments of the present disclosure.

FIG. 17 is an illustration of an exemplary gantry for installing a shear web within a wind turbine blade shell according to embodiments of the present disclosure.

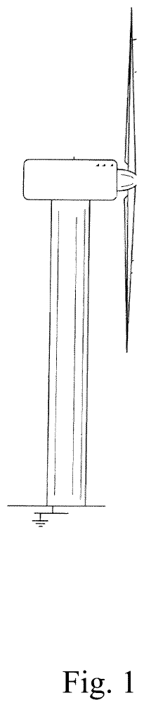

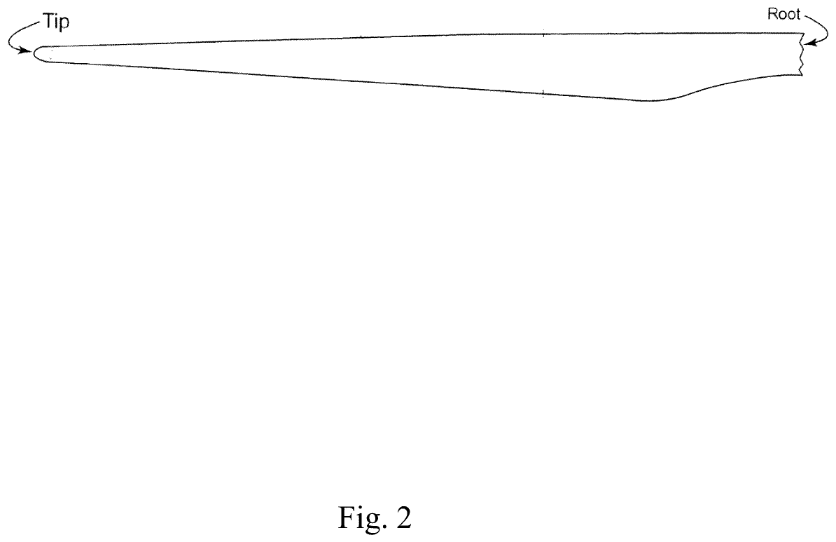

### DETAILED DESCRIPTION

Reference will now be made in detail to exemplary embodiments of the disclosed subject matter, an example of which is illustrated in the accompanying drawings. The method and corresponding steps of the disclosed subject matter will be described in conjunction with the detailed description of the system. While the illustrative embodiment(s) depict a wind turbine blade, it is to be understood that the present disclosure is applicable to any composite (e.g. glass or carbon fiber) panel, such as automobile doors and body panels.

Modern wind turbine rotor blades are built from fiber-reinforced plastics as fiber-reinforced plastics have high strength-to-weight ratios. A rotor blade typically includes an airfoil shape having a rounded leading edge and a sharp trailing edge and the blade includes a blade root that connects to a hub of the turbine. Multiple rotor blades are connected at the respective blade root to the hub to create the wind turbine. The blade root includes a plurality of root bushings set within the fiber-reinforced polymer that provides reinforcement to the blade. Bolts are engaged with threads in the root bushings to connect the blade root to the hub.

A typical turbine blade is made by molding two half-shells in a pair of molds. A spar cap (analogous to the spar in an aircraft wing), web stiffeners (ribs) and other details may be optionally installed into one of the blade halves. Adhesive is applied to the bonding perimeter/edges of the first shell, for example, in equally-spaced beads. The second half shell is then turned over, still in its mold tool, and lowered onto the first. The molds are pressed together and the adhesive is allowed to cure, joining the two halves of the blade together. This process by which the two blade halves are joined together with paste is called blade closure.

In various embodiments, the mold may be made out of any suitable metal as is known in the art. In various embodiments, the mold may include a metal, such as, for example, aluminum, steel, stainless steel, titanium, tantalum, tungsten, or any suitable combination of metals (e.g., a metal alloy). In various embodiments, the mold may include a polymer, for example, polyethylene, polyurethane, polyethylene terephthalate, polyvinyl chloride, etc. In various embodiments, the mold may be made by machining (e.g., CNC machining), 3D printing (e.g., using Direct Metal Laser Sintering (DMLS) and Fused Deposition Modeling (FDM)), open molding, closed molding, resin infusion, compression molding, composite hand layup, injection molding, pultrusion, automated fiber placement, tube rolling, automated tape laying, filament winding, resin transfer molding, or any suitable manufacturing technique as is known in the art. One skilled in the art will recognize that any suitable 3D printing technique may be used to manufacture the components described herein.

The blade shells (i.e. high pressure side and low pressure side, or “inner” and “outer”) of the blade are made of a fiber-reinforced polymer, such as fiberglass-reinforced epoxy resin. Other suitable fiber reinforcements may be incorporated together with other fibers or independently, such as, for example, carbon fiber (unidirectional and/or bidirectional), Kevlar, fiberglass (unidirectional and/or bidirectional), etc. Moreover, the blade shells may include any suitable number of layers of fiber reinforcement for the desired thickness and properties of the part. The core is made of any suitable material, such as, for example, a polymer foam (e.g., polyurethane, divinylcell, polyisocyanurate, etc.), a sandwich core (e.g., nomex honeycomb, aluminum honeycomb, balsa, etc.), and/or a polymer honeycomb material.

In forming the composite structure, e.g., wind turbine blade, polymers (which are epoxy based resin systems) are inserted into the mold in a series of panels or “layups”. After reaching the designed degree of cure, these polymer layup segments serve as the matrix component in a composite structure to enable the uniform load sharing between reinforcement fibers thereby creating the ultimate mechanical strength in the part. While the cure process could progress in ambient temperature in some cases, in most applications including fabrication of wind turbine blades, external heat sources are employed.

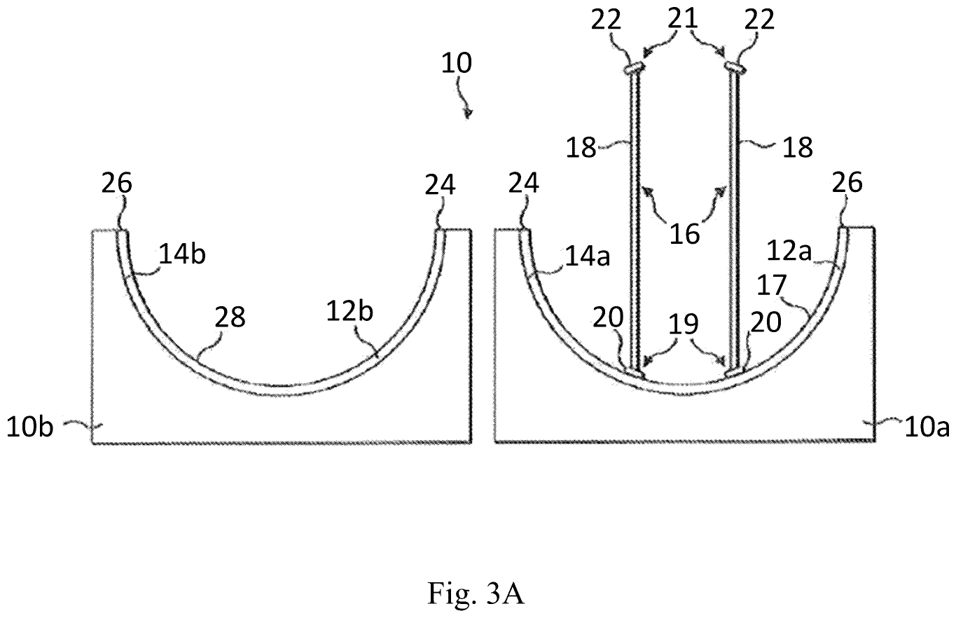

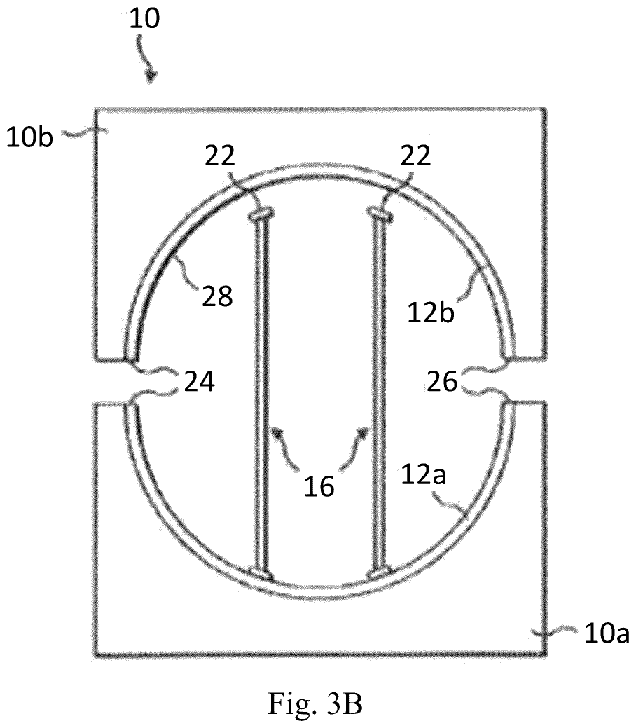

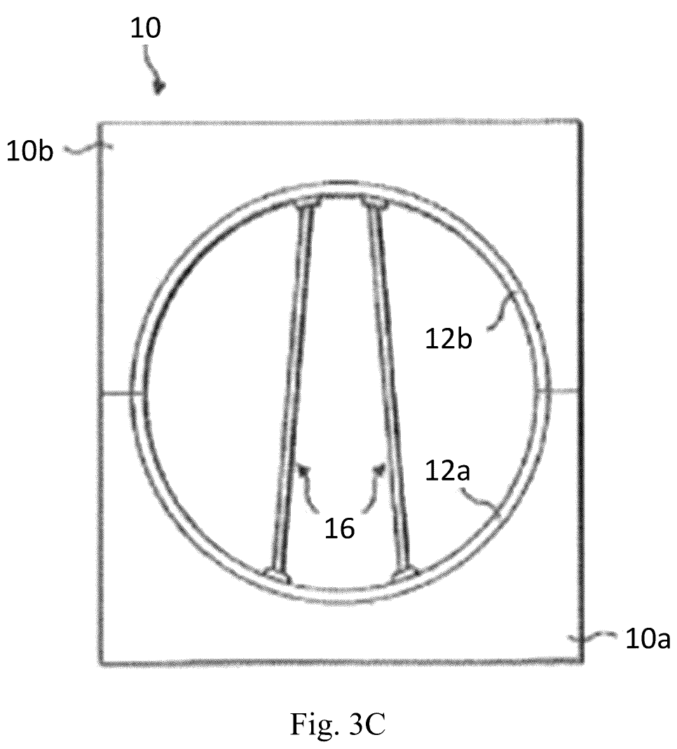

Referring to FIG. 3A, this shows a mold 10 for a wind turbine blade divided into two half molds, an upper suction-side mold 10a and a lower pressure-side mold 10b, which are arranged side by side in an open configuration of the mold. A pressure side blade shell 12a is supported on a mold surface 14a of the lower mold 10a and a suction side blade shell 12b is supported on a mold surface 14b of the upper mold 10b. The shells 12a, 12b are each made up of a plurality of glass-fiber fabric layers, which are bonded together by cured resin.

After forming the shells 12a, 12b in the respective mold halves 10a, 10b, shear webs 16 are bonded to an inner surface 17 of the windward blade shell 12a. The shear webs 16 are longitudinally-extending structures that bridge the two half shells 12a, 12b of the blade and serve to transfer shear loads from the blade to the wind turbine hub in use. In cross-section, as shown in FIG. 3A, the shear webs 16 each comprise a web 18 having a lower edge 19 comprising a first longitudinally-extending mounting flange 20 and an upper edge 21 comprising a second longitudinally-extending mounting flange 22. Adhesive such as epoxy is applied along these mounting flanges 20, 22 in order to bond the shear webs 16 to the respective half shells 12a, 12b.

As shown in FIG. 3B, once the shear webs 16 have been bonded to the inner surface 17 of the windward blade shell 12a, adhesive is applied along the second (upper) mounting flanges 22 of the shear webs 16, and along the leading edge 24 and trailing edge 26 of the blade shells 12a, 12b. The upper mold 10b, including the upper blade shell 12b, is then lifted, turned and placed on top of the lower blade mold 10a in order to bond the two blade half shells 12a, 12b together along the leading and trailing edges 24, 26 and to bond the shear webs 16 to an inner surface 28 of the upper blade shell 12b. The step of placing one mold half on top of the other is referred to as closing the mold.

Referring now to FIG. 3C, a problem can arise when the mold 10 is closed whereby the shear webs 16 may move slightly relative to the upper shell 12b. For example, the shear webs 16 may move slightly under their own weight during mold closing or they may be dislodged by contact with the upper shell 12b. Alternatively or additionally, the shear webs 16 may not be completely bonded to the respective half shells 12a, 12b. The concave curvature of the upper shell 12b also has a tendency to force the shear webs 16 together slightly, as shown in FIG. 3C. Such movement of the shear webs 16 during mold closing may result in the shear webs 16 being bonded to the upper shell 12b at a sub-optimal position.

Although two shear webs are depicted in the exemplary embodiment, alternative numbers (i.e., more or less) shear webs can be employed within the scope of the present disclosure. Furthermore, although the shear web is depicted as an I-beam construction, alternative shear web configurations can be employed, e.g., split beams having generally a U-shape or V-shape construction, if so desired.

In a conventional fabrication of turbine blades' shells heating wires are built into the tooling structure, e.g., the underlying mold surface, which act as heat sources on only the mold surface (called “A-surface”) to support the cure process. An obvious shortcoming of this approach is that there is no direct heating on the surface of the blade that is not in direct contact with the mold (called the “B-surface”). Instead, the heat from the wires must propagate through the thickness of the blade, via conduction which is limited by the coefficient of conduction of the particular materials used and their relative thicknesses, to reach the B-surface of the blade.

Accordingly, an aspect of the present disclosure provides a system/apparatus and method for curing different geometries of composite panels (e.g., wind turbine blades and various structures incorporated therein such as core/foam, spar caps, etc.) which can have varying radii of curvature, and/or taper (e.g., root to tip) and different materials and chemicals (e.g., carbon or glass fibers; accompanying resins, epoxies; adhesives to bond components together; etc.). The present disclosure provides a ready to use system that can be incorporated (e.g., embedded between the layers of a composite structure, or applied on top/bottom of a compositive structure) directly onto/within the composite structure and designed for kinetics of the particular chemicals present in that composite structure(s).

In some embodiments, a controller system allows tracing the temperature at various points along the blade span, and logging the sensed data during the curing process such that a histogram of the entire blade can be recorded and analyzed (e.g., cure time, max/min temperatures recorded, etc.). Additionally, the present disclosure provides for active control of temperature along the blade span-without the need for pre-determined heating profiles. Also, the present disclosure can be applied to reach, and maintain, any desired ramp up (whether a heating frequency, or a time goal) and any temperature due to reaction kinetics of chemical. As there are many different chemicals used in the manufacture of wind turbine blades, each having different reaction kinetics due to their chemical structure, the system disclosed herein can be adapted and tailored according to those chemicals because limitations (such as maximum curing temperature or maximum ramp up rate). To determine the particular kinetic reaction characteristics of a given composite, chemical properties from technical data sheets are imported and small scale temperature development tests are performed to decide the limits of the curing system.

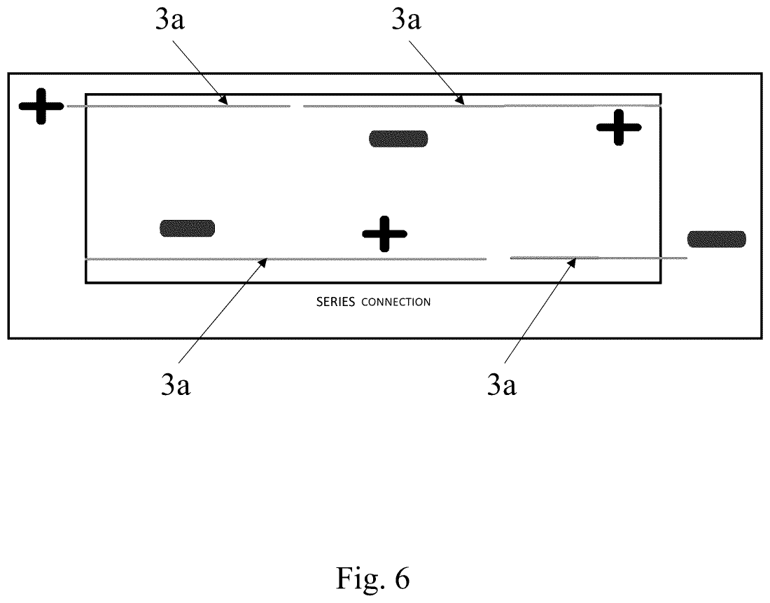

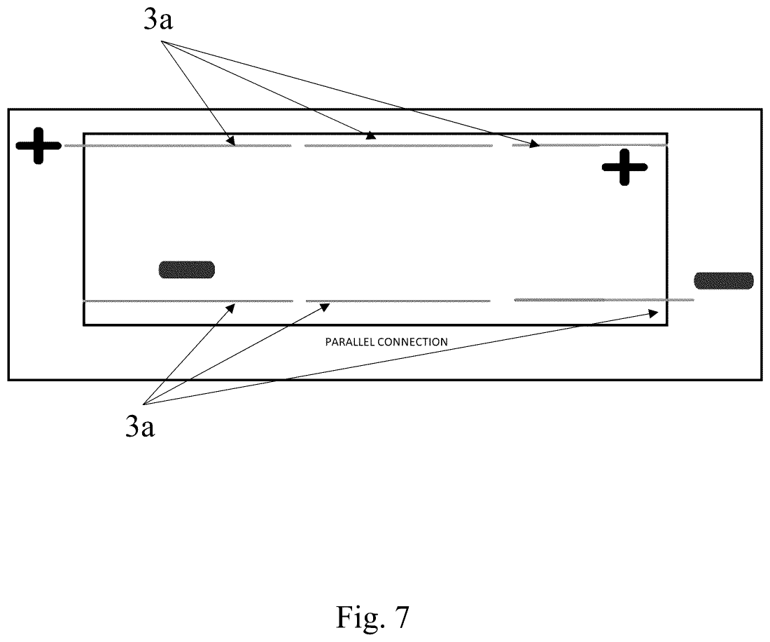

The present disclosure provides curing time optimization of chemicals being used in composite structure (e.g., wind turbine blade) manufacturing. In an exemplary embodiment, metallic (e.g., copper) strips are bonded to the composite panel surface to establish an electrical current circuit (with connections to a power source). The placement of the strips can be determined based on the surface geometry (e.g., contour) and dimension (blade vs root) of the composite panel on which the strip is attached. Accordingly, the flow/design pattern of the strips can be variable and reversible. For purpose of illustration and not limitation, FIG. 6 depicts an exemplary embodiment of a plurality of strips 3a configured in a series orientation; FIG. 7 depicts an exemplary embodiment of a plurality of strips 3a configured in a parallel orientation. Additionally or alternatively, the strips 3a can be configured in both a series and parallel configuration (and the pattern can vary along the blade length so as to be a non-uniform arrangement throughout). As shown in FIGS. 6-7, a negative charge is presented on the “bottom” strip 3a, while a positive charge is presented on the “top” strip 3a to create a differential between the adjacent strips.

Then, a conductive (e.g., carbon based) paint is applied over the metallic strips, and spanning the space between the strips to create a continuous surface layer. This allows the current flow in the covered/painted area to generate heat when a power source is connected. For embodiments in which a specific circuit design is desired, an insulator (e.g., masking tape) can be applied in the desired geometry/pattern to prohibit paint from being deposited on select surfaces, which in turn defines a circuit pattern in the non-masked portions receiving the conductive paint. The present disclosure provides for visualization of the heat applied to the composite product. For example, an infrared (IR) camera can be employed to reveal the area(s) between the copper strips 3a which are colored (signaling a difference in temperature) on the camera screen when the power source is connected. The visibility and color variance illustrated depends on, and changes according to, the homogeneity of the painting applied to the composite. If there is a significant difference in the thickness of the paint layer across the composite panel, this will result in non-homogenous heating—and therefore non-homogenous visibility (i.e., color differentiation will be apparent) in the IR camera.

When the metallic strips are connected to a power source and a current is applied, the carbon paint will start to increase in temperature, thereby illustrating the resistance of the strips. In some embodiments, the electrical current is applied in a steady state manner; in other embodiments the electrical current is applied in a pulsed or transient manner. While the external power supply (e.g., electrical box 6, electrical box with toroidal transformer) can be attached directly, and only, to the copper strips 3a, once current is applied through the strips 3a the current is also transmitted/flows through the carbon paint layer 3.

The present disclosure also provides selective/targeted heating for blade component (e.g., spar cap; flange, etc.) curing, bonding and hand layup application. This focused heating, on the B-surface (i.e., opposite of mold surface) of the composite component, prevents potential uncured and late cure situations—thereby decreasing cycle-time. Conventionally, there is no direct heating system to cure the bonding paste associated with the girders/spar caps before shear web bonding. The present disclosure provides bonding improvement in this area to accelerate the shear web adhesive cure time, to ensure the shear web is sufficiently rigidly coupled to the first blade half before the second half of the blade mold/shell is rotated into a closed position (which can often impart forces on the shear web and inadvertently dislodge the shear web if the adhesive is not completely cured). As such, the present disclosure effectively shortens blade manufacture cycle time, improves integrity of adhesive bonds of wind turbine blade manufacturing. Furthermore, the amount of heat applied to enhance curing can be varied according to blade location (e.g., a greater current can be applied to the root section as compared to the tip section of the blade since the root section is typically thicker).

In an exemplary embodiment, a heating tool is provided and placed over the shear-web/spar cap bond location of the blade to accelerate curing the adhesive with nearly direct heat—as opposed to simple conduction from the mold surface through the spar cap to heat the bonding paste. Additionally, the layup segments or panels of composite layers, can be cured by hot air or heater blanket and controlled by operators. However, in some instances a heater blanket and hot air system are not sufficient (e.g., due to geometry constraints of the blade design) and results in uncured and late cured laminations. The heating system disclosed herein does not require any wiring in the mold itself, nor wires within the composite panel itself (which can result in rich-resin density issues in some cases and cause over-heating at some locations). The heating paint of the present disclosure does not require additional wiring, but instead provides carbon based paint between composite layers, and the carbon paint is maintenance free. Also, this system can provide more homogeneous heating on mold surface, reduction in electrical power consumption and faster curing/cycle time improvement. Thus, in accordance with an aspect of the present disclosure, a heating paint system provides a solution to prevent financial and material losses caused by uncured and late cured laminations on hand layup applications. The system disclosed herein can also be used for datalogging and traceable curing of the finish processes. Furthermore, this system can be used as mold heater instead of resistance wiring system.

The energy to be applied by the system disclosed herein can be calculated, in advance of operation so as to accurately predict the resources (e.g., time, cost, electrical input, conductive tape dimensions, etc.) based on the parameters of the composite product to be formed. For example, the electrical source (“Q”) is governed by the following equations.

$$Q = m \times C \times Δ T + {Q}_{l o s s}$$

Where: m=mass (kg)
C_{p gfrp}=specific heat capacity of gfrp (J/kgK)
ΔT=change in temperature (K)
Qₗₒₛₛ=amount of heat loss to ambient air (J)
   The power requirement for generating the current through the strips (and carbon paint layer(s)) is governed by the following equation:

$$P = Q / t$$

Where: P=Power amount (W)
Q=Energy amount (J)
t=time(s)
   The thermal resistance of the copper strip(s) is governed by the following equation:

$$Thermal Resistance = R = \frac{1}{A} [ \frac{1}{{h}_{a m b i e n t}} + \frac{{L}_{r u b b e r}}{{k}_{r u b b e r}} + \frac{{L}_{gfrp}}{{k}_{gfrp}} + \frac{{L}_{gfrpshell}}{{k}_{gfrp}} + \frac{1}{{h}_{a irshell}} ]$$

$$Overall Heat Transfer Coefficient = {U}_{overall} = \frac{1}{R}$$

$${P}_{loss} = {U}_{overall} xAx Δ T$$

### Where:

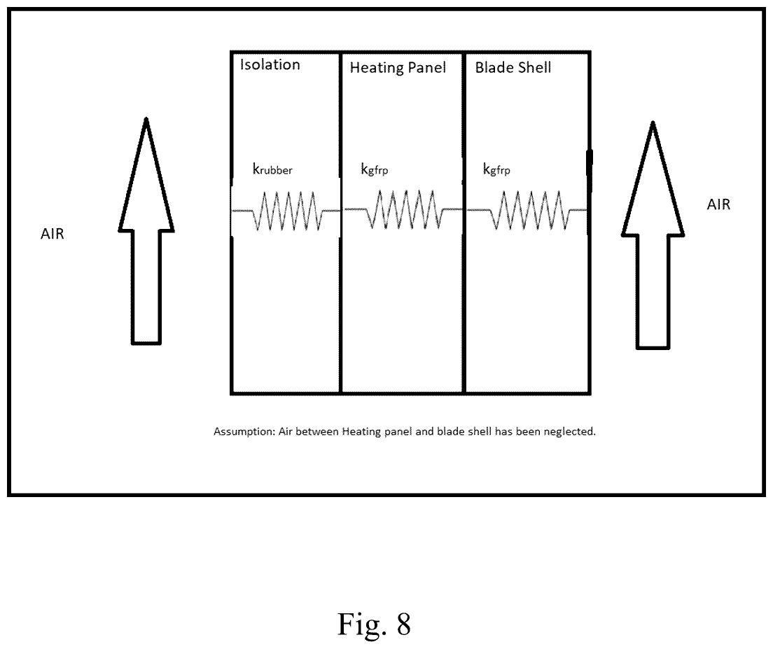

L_{gfrpshell}=Thickness blade shell lamination (m)
k_{gfrp}=Thermal conductivity of heating panel (W/mK)
L_{gfrp}=Thickness heating panel (m)
L_{rubber}=Thickness of rubber layer (m)
k_{rubber}=Thermal conductivity of rubber (W/mK)
h_{ambient}=Heat transfer coefficient of ambient (W/m²K)
hₐᵢᵣₛₕₑₗₗ=Heat transfer coefficient of air inside blade (W/m²K)
R=Thermal Resistance (m²K/W)
Pₗₒₛₛ=Power loss due to convection (W)
Uₒᵥₑᵣₐₗₗ=Overall heat transfer coefficient (W/m²K)
ΔT=change in temperature (K)
A=Surface area of panel (m²)
   FIG. 8 depicts an exemplary embodiment of the configuration of these various parameters.
   The ratio of the difference between tape width and tape length affects the resistance of the system. As the ratio of the difference between tape width and tape length increases, the more time is required to reach a desired temperature on the composite surface. Conversely, as the difference between the tape width and tape length decreases, the less time that is required to reach a desired temperature on the composite surface. The heating circuit of conductive tape (and paint), can be separated or diverted to several parts, areas, distinct zones or systems along the span of the blade. These zones can be connected in parallel or serial manner. In some embodiments, the plurality of distinct zones are configured in a symmetric pattern in order to provide a uniform/homogenous heated region. However, the distinct zones can be arranged in an asymmetrical pattern, if so desired.

As described above, each of the copper strips (or “tape”) placed on the composite laminate have an inherent resistance. The overall resistance of the heating system disclosed herein is governed by the following equation:

$$RESISTANCE = \frac{DIFFERENCE BETWEEN TWO PARALLEL TAPE}{TAPE LENGTH} * RESISTANCE OF THE COATING$$

With the numerator being calculated by measuring the distance between the two copper strips or “tape”.

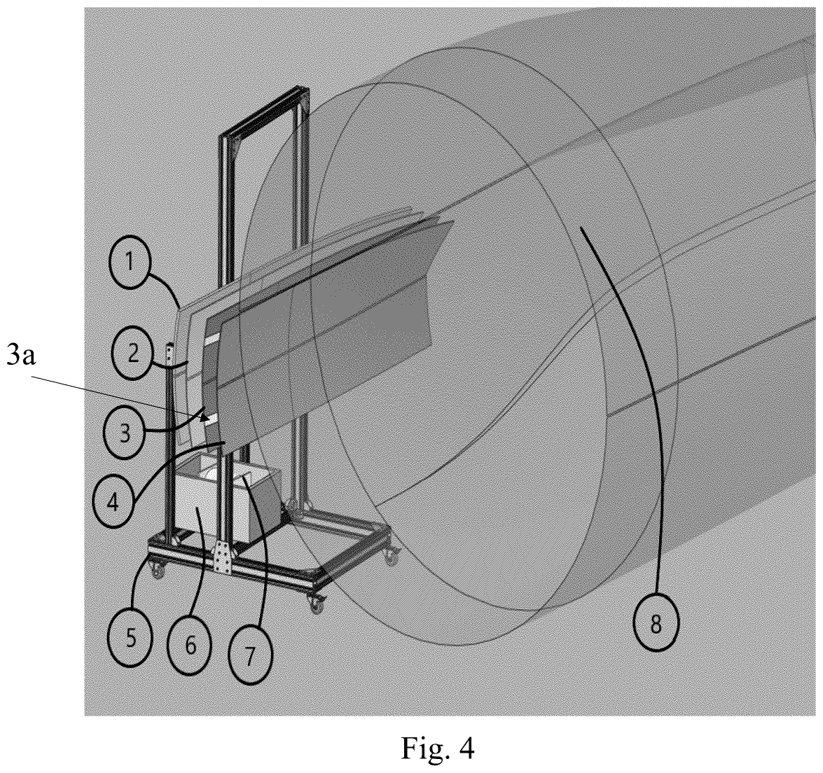

For purpose of illustration and not limitation, an exemplary embodiment of the present disclosure is shown in FIG. 4 depicting the following elements:

### 1: Thermal Isolation Layer

The thermal isolation layer 1 can vary in size (e.g., thickness and length/width) (and/or material choice) being scaled according to the amount of heat expected to be generated by the copper strip/tape 3 so as to be thick/dense enough to maintain a thermal barrier between the outer surface and the underlying surface which is adjacent to the composite panel 2 which is the target for receiving the heat applied via the current flowing through the strip/tape 3. The thermal isolation layer can be a variety of materials, e.g., polyurethane based or rubber. The greater the thickness of this layer, the greater thermal isolation characteristic provided, e.g., in some embodiments a thickness of 13 mm is employed. In some embodiments, a thermal isolation layer thickness of 5 mm, 15 mm, or 20 mm is employed. The thermal isolation layer 1 inhibits or prohibits heat transfer away from the mold/layup segments, thereby increasing both efficacy of the heating (i.e. all heat is directed in one direction, towards the underlying composite layups to expedite curing of the resin and/or adhesive), as well as safety (i.e. operators can perform additional tasks on the blade adjacent to the heating apparatus disclosed herein, without risk of burn or injury). The thermal isolation layer 1 can be separated from the underlying composite panel 2, and repositioned as desired along the length of the blade.

### 2: Composite Panel for Curing Area

The composite panel 2 can be any layup segment to be included into the wind turbine blade (e.g., to be positioned at any location along the blade span). The panel can include elongated fibers (e.g. glass, carbon, aramid) woven or otherwise connected, with or without a binding resin. In an exemplary embodiment, the composite panel 2 is positioned at a location that coincides with a spar cap position (to facilitate localized heating to cure the bond as described herein). In the embodiment shown in FIG. 4, two panels are employed, and positioned in an adjacent/abutting relationship such that they are coplanar or “flush” with each other.

### 3a: Copper Tape (3a) and Carbon Coating (3)

The conductive (e.g., copper, aluminum, silver, nickel, carbon-based) tape/strip 3a can be applied directly on the composite panel 2 in a variety of patterns. For example, the copper tape can extend in a linear fashion along the entire composite panel 2 length (and thus along the entire blade span). Additionally or alternatively, the copper tape 3a can be arranged in a curvilinear manner along the composite panel 2. Also, the copper tape 3a can extend in a contiguous manner, having a constant width along its entire length; alternatively, the width of the copper tape can be varied at select locations. In the embodiment shown, two strips of copper tape 3a are employed, and arranged in a parallel manner. However, alternative configurations are possible—e.g., converging or intersecting strips can be employed to generate a more concentrated thermal gradient at select locations along the composite panel 2. The width of the copper strips 3a and the space or gap between adjacent strips is selected according to the governing equations disclosed herein to generate the desired resistance/heating for the particular composite panel 2 size (thickness, length or width), material (e.g., glass vs. carbon fiber) and location (e.g., root vs. tip).

After the copper tape 3a is attached to the composite panel 2 in the desired configuration, a layer(s) of conductive paint 3 is applied over, and adjacent to, the copper tape 3a. The carbon paint 3 is in electrical contact with the copper tape 3a and thereby transmits the heat generated by the current passing though the copper strips 3a and evenly dissipates, via the carbon paint layer, the heat across the entire surface area of the composite panel 2 to provide a homogenous heating temperature. As shown, the carbon layer 3 can extend about a greater (e.g., order(s) of magnitude greater) surface area of the panel 2 than the copper strip 3a extends about the composite panel 2.

Thus, in accordance with an aspect of the disclosure, the apparatus disclosed herein can be employed as external heating tools for curing the desired location of the blade. Those components are external/removable tools that do not form part of the competed blade or final product.

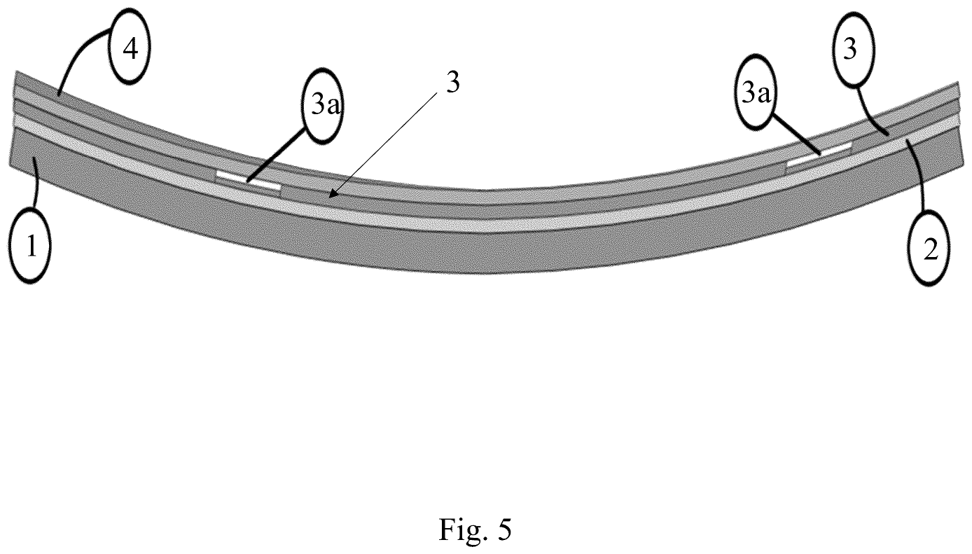

Referring now to FIG. 5, a cross sectional view of the exemplary device of FIG. 4 is shown including:
1: Thermal Isolation Layer
2: Composite Panel for curing area
3a: Copper tape
3: Carbon Coatings (e.g., paint)
4: Protection Layer

As shown in FIG. 5, the copper strip 3a is applied directly to the composite panel 2. The carbon paint 3 is applied on top of, and adjacent to the strip(s) 3a. Thus a single “thermal layer” of the cross section includes two distinct subcomponents (copper strips 3a and carbon paint 3) at those locations in which the copper strip is deposited; the remainder of the “thermal layer” is only the carbon paint 3, as shown.

The conductive tape 3a and the copper paint layer(s) 3, which are coupled to an electrical power source, provide a localized heating source which is in direct contact to apply conductive heat transfer to the composite panel 2. This is advantageous over electrical wiring as it avoids kinks to the wiring which can damage the composite panel and result in undesired arcing of the wire. Therefore, the present disclosure provides for direct heating of complex geometries, e.g., wind turbine blades having varying thickness, and contours, along the blade span. Similarly, this technique is advantageous over applying heated air (e.g., fans or ducts) as that method only provides convective heat transfer, and requires complex equipment and suffers from excessive heat loss to ambient air.

It is to be understood that the exemplary embodiment described herein employing carbon as the coating 3 is for purpose of illustration only and not limitation. The coating 3 has nanomaterials therein which are electrically conductive, for example, and not limited to, electrically conductive nanotubes, nanographene, nanographene ribbons, transformed nanomaterials. In some embodiments, the coating is between 0.0001 and 1.0 inches thick.

### 4: Protection Layer

Referring again to FIG. 4, the protection layer 4 is positioned adjacent to the copper tape 3a and carbon painted layer 3. In the embodiment shown, the protection layer 4 extends at least as long/wide as the thermal layer (i.e., combination of copper strips 3a and carbon paint 3), though this protection layer can be configured with greater dimensions to ensure the thermal layer is not damaged. This protection layer can be made of the same material as the underlying composite product (e.g. made of the same materials of wind turbine blade, which can include glass fabrics (2× layers Biax1000 gsm) and epoxy infusion resin). The dimensions of this layer can vary and differ due to different geometries of the area in which the apparatus is applied, and for purpose of illustration and not limitation an exemplary embodiment extends for an area of at least 50 mm further from the edges of the painted area. The protection layer(s) are bonded chemically and physically to the main heating panel from the edges, and in some embodiments remain fixedly coupled thereto.

### 5: Carrying Cart

The apparatus of the present disclosure can include a carrying cart 5 which is mobile (e.g., can include casters) to maneuver the holding element to any desired location along a blade. In some embodiments, the carrying cart can include a programmable onboard computer which receives coordinates (shop floor, or blade geometry) for deployment and automatically steers the apparatus to the desired location. In other embodiments, the cart 5 can be moved manually to the desired location. In some embodiments, the cart 5 can be moved along a guided track laid around the wind turbine blade 8 or blade shells 12a, b. In some embodiments, the cart 5 can be made from 80/20 T-slotted bars.

### 6: Electrical Box

The apparatus of the present disclosure can include a power source electrical box 6 which provides local power (e.g., battery) to deliver current to the copper strips 3a—at location of the cart/blade. This avoids the need for wiring and trip hazards along the shop floor.

### 7: Toroidal Transformer and Controller

A toroidal transformer 7 can be included within the power source 6 to increase (step-up) or decrease (step-down) voltages without changing the frequency of the electric current applied to the copper strips 3a.

As shown in FIGS. 6-8, an electrical current can be provided to the copper strips 3a, which can be configured in series with alternating positive/negative charges along each strip (as shown in FIG. 6) or in a parallel configuration with dedicated strips for positive/negative charges (as shown in FIG. 7).

### 8: Wind Turbine Blade

For reference, a wind turbine blade is also depicted in FIG. 4 illustrating the application of the present disclosure at an exemplary location on the blade. This exemplary embodiment depicts the apparatus of the present disclosure positioned near the reinforcement area of the two blade halves (after closure), however the apparatus can be employed at other locations (e.g., shear web and spar cap bonding sites).

Also, this exemplary embodiment depicts the apparatus of the present disclosure positioned at a location exterior of the blade, however the apparatus can also be employed to operate at locations within the blade interior and along the blade span (e.g., spaced away from the open root). In such internal applications, the heating apparatus of layers 1-4 are removed from the cart 5 and positioned at the desired location within the blade.

For purpose of illustration and not limitation, in some embodiments the following components can be employed:

| Part Name | Detail explanation |
|---|---|
| Carbon Coatings | Water, natural graphite, pure acrylics |
| | dispersion, carbon black, additives, |
| | preservative (BIT, INN, MIT). |
| Copper Tape | %100 pure copper |
| Controller | Temperature PID controller |
| Toroidal Transformer | Reduced to Voltage 220 V to 48 V |
| Connection cables | Copper 10 mm² cables |
| Carrying Cart | Panel and Transformer carrier |
| Composite Panel | GFRP Panel produced by TPI |
| Isolation Layer | Rubber |

### Shear Web Heating

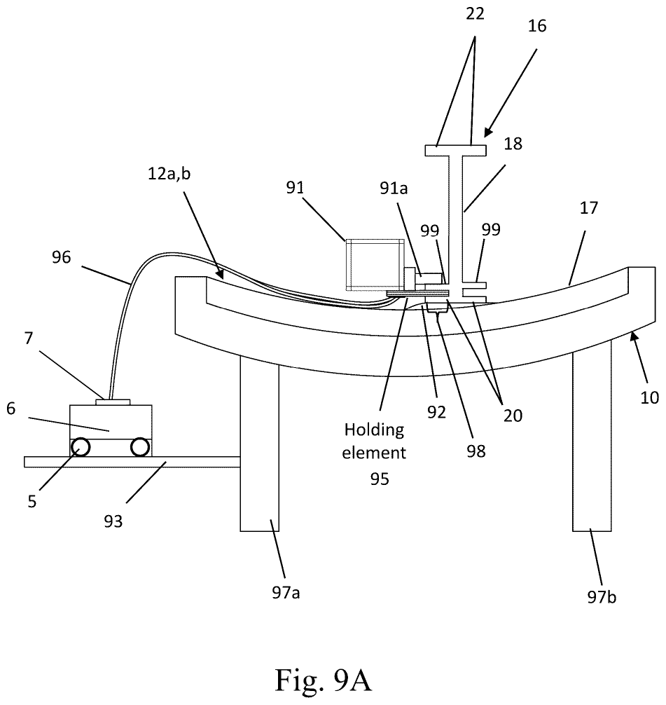

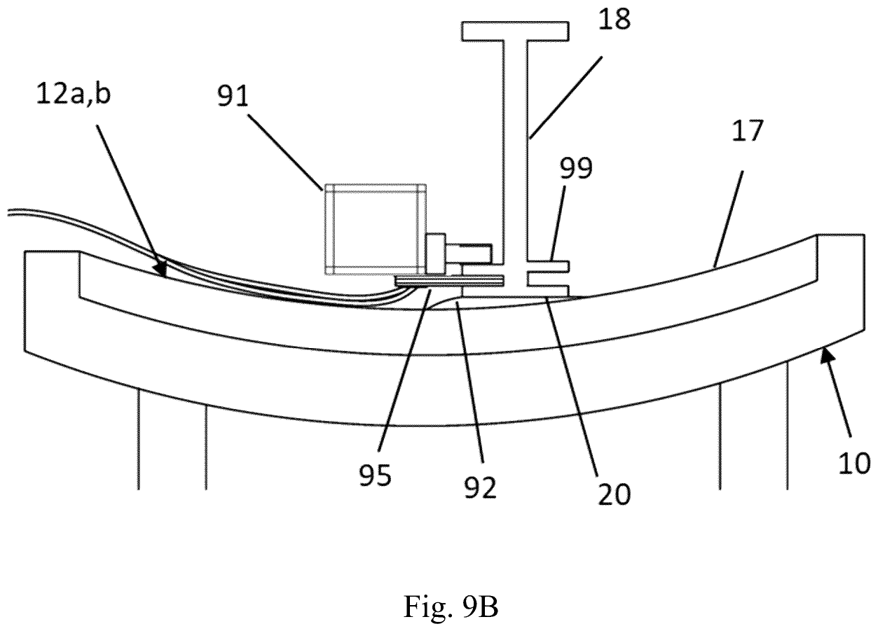

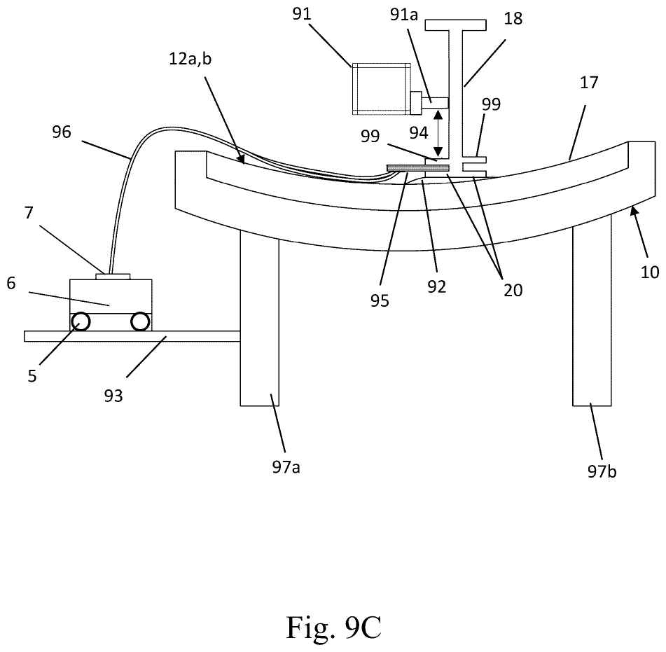

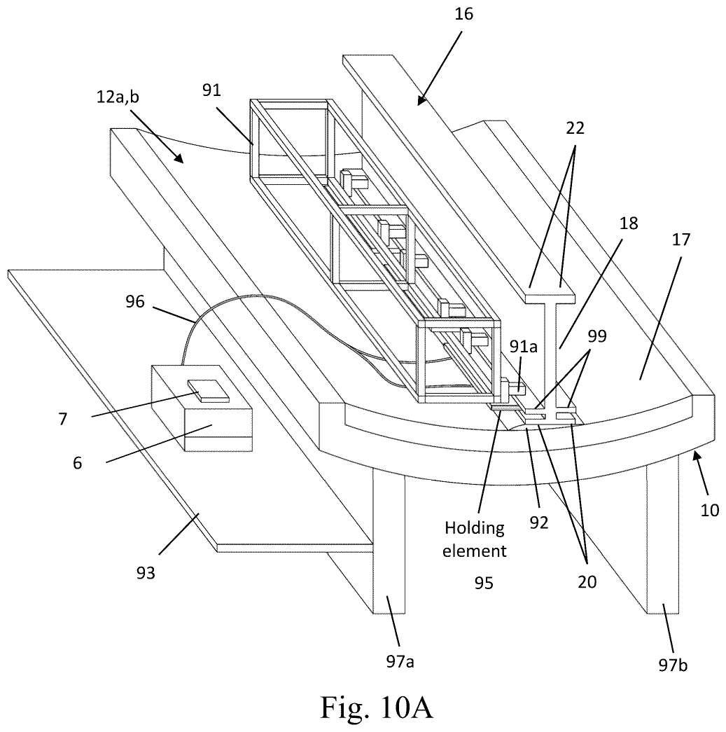

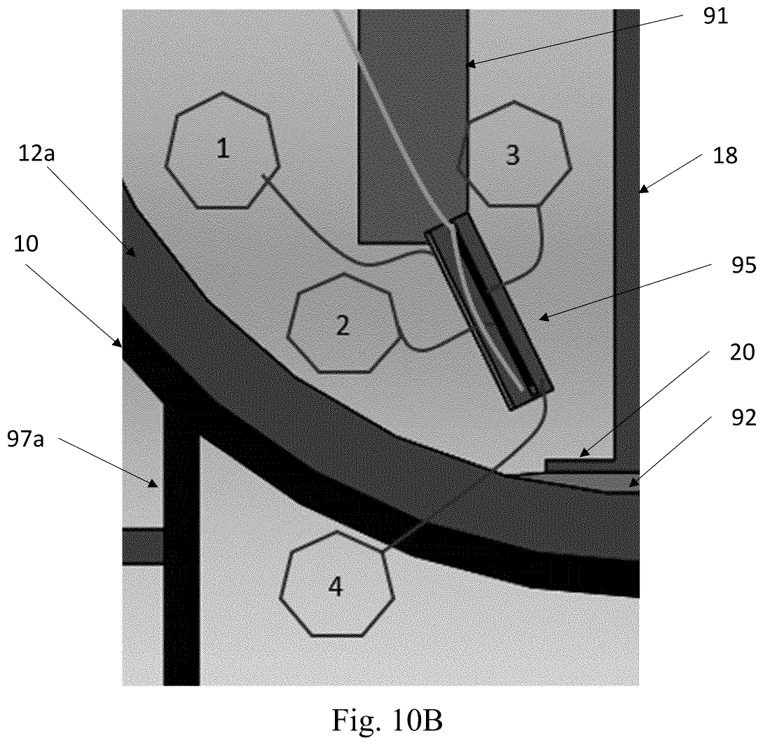

In accordance with another aspect of the disclosure, the heating apparatus can be employed in conjunction with the installment of a shear web (or “girder”). An exemplary embodiment is shown in FIGS. 9A-B, with the heating apparatus provided as a separate (and removable) component from the blade mold (as well as the blade skins formed therein, and the shear web). As shown in spanwise view (i.e., looking from blade root towards the blade tip) of FIGS. 9A-B, a heating device, which can include the same components (e.g., thermal isolation layer 1, composite panel for curing area 2, copper tape 3a and carbon coating 3, a protection layer 4) as described above in connection with FIGS. 4-5, is provided in connection with the load-carrying struts 91 of the shear web gantry. In other words, the overhead gantry which has structural members (e.g., trusses, clamps, etc.) for lifting and holding the shear web during installation into a blade half on the open molds also includes a heating apparatus, labeled as the “holding element” in FIGS. 9A-B. Additionally, an electrical box 6, a toroidal transformer and controller 7 are provided to generate the electrical current to induce heat within the holding element; these power control components can be located external to the wind turbine blade shells 12a, b. Also shown in FIGS. 9A-B, and FIG. 10 are shear web 16, bonding paste 92 disposed between the blade shell and shear web, a walking path 93, a carrying cart 5, wiring 96, a mold 10 of a wind turbine blade shell, and vertical supporting members 97a, 97b.

Still referring to FIGS. 9A-B and in greater detail, the apparatus of the present disclosure can include a carrying cart 5 which is mobile to maneuver the power source and wiring 96 to any desired location along a wind turbine blade shell 12a, b. The wiring 96 forms an electrical connection between the electrical box 6 and the heating elements of the holding element including the thermal isolation layer 1, the composite panel for curing area 2, and the copper tape 3a and carbon coating 3. The holding element 95 can be coupled with load-carrying struts 91 of the shear web gantry, the gantry holder system comprising gantry holders 91a. In some embodiments, the holding element 95 is separate, or spaced from, the load-carrying struts 91 of the shear web gantry, such that the holding element itself does not support the weight of the shear web as the web is brought into vertical alignment with the spar cap formed in the blade shell 12a,b. The shear web gantry connects to the shear web 16 (e.g., along the vertical portion of the I-beam) as shown in FIG. 9C and the holding element 95 is spaced a distance 94 from the connection between the load-carrying struts 91 of the shear web gantry and the shear web 16. The holding element 95 can be coupled to the gantry strut 91 before the shear web is lifted by the gantry, with both the shear web 16 and holding element 95 being positioned inside the blade shell 12a,b simultaneously. Additionally or alternatively, the gantry struts 91 can lift the shear web 16 and deliver the shear web to the desired location within the blade shell 12a,b, with the holding element 95 thereafter being coupled to the shear web (e.g., inserted laterally within the channel formed by the flanges 99 and 20 of the shear web).

The holding element 95 can be an elongated or rectangular member that has an electrical connection at a first side (opposite the shear web flange) and a second side that is formed with a size and shape to match or compliment the portion of the shear web flange the holding element is to engage and transfer heat. This maximizes the surface area in contact and optimizes the heat transfer into the web (and underlying spar cap). The holding element 95 can be oriented perpendicular to the shear web 18, or angled thereto (e.g. pivotable about a hinge). In some embodiments the lower surface of the holding element can have a non-planar profile (e.g. undulating or constant slope) to accommodate varying shear web and spar cap designs. Also, the holding element 95 can be moved (e.g. translated) along the gantry/girder separately from the struts 91 which support the weight of the shear web.

A toroidal transformer and controller 7 can be included with the carrying cart 5 to increase or decrease the voltage supplied to the holding element. The carrying cart 5 can be elevated from the ground on a walking path 93 coupled (e.g., welded, bolted) to one of the vertical supporting members 97(a-b) of the mold 10 of the wind turbine blade shell 12a, b. The mold 10 is a hollow cavity shaped to import the desired contour to the wind turbine blade shells 12a, b. The bonding paste 92 can completely cover or partially cover the contact area between the bottom of the shear web 16 and the wind turbine blade shell 12a,b. Paste can be dispensed along the blade shell 12a,b before the shear web 16 is brought into alignment with the spar cap. The shear web 16 can include a web 18 having a lower edge comprising a first longitudinally-extending mounting flange 20 and an upper edge comprising a second longitudinally-extending mounting flange 22. Adhesive 92 such as epoxy, polyurethane adhesives, or acrylic adhesive can be applied along the mounting flanges 20, 22 to bond the shear web 16 to the interior surface 17 of the blade shell 12a,b.

The shear web 16 can be different shapes or configurations. In some embodiments, the shear web can be a standard shape like an I-beam or an H-beam. In other embodiments, the shear web can be custom-designed having curved flanges. In some embodiments, the shear web 16 can comprise additional flanges 99 as shown in FIGS. 9A-B. In those embodiments, the additional flanges are spaced a distance from the flanges 20 such that they form a C-channel with a gap or channel defined between upper and lower flanges along the bottom edge of the shear web. In some embodiments, the width 98 of the mounting flanges 20, 22 and additional flanges 99 can vary along the longitudinal length, or blade span, of the shear web 16 (i.e., the dimension into the page of FIGS. 9A-B). In some embodiments, the width 98 of the mounting flanges 20, 22 and additional flanges 99 can be constant along the longitudinal length of the shear web (i.e., the dimension into the page of FIGS. 9A-B).

In some embodiments, the amount of bonding paste 92 covering the area between the bottom of the shear web 16 (i.e., the surface of the mounting flanges 20, 22 coming into contact with the wind turbine blade shell 12a,b) and the wind turbine blade shell 12a,b can vary (e.g., less paste or more paste in distinct zones of the wind turbine blade shell 12a,b compared to other zones). Varying the amount of bonding paste 92 can allow for inhomogeneous curing of the paste. Inhomogeneous curing can be a desirable result to have ‘targeted heating’ of distinct zones or areas where curing may be a challenge (e.g., zones identified as forming a weaker bond between the shear web 16 and the wind turbine shell 12a,b).

In some embodiments, the bonding paste 92 can be disposed on the bottom of the shear web 16 and then brought into contact with the interior surface 17 of the wind turbine blade shell 12a,b. In some embodiments, the bonding paste 92 can be disposed on the interior surface 17 of the wind turbine blade shell 12a,b and then brought into contact with the bottom of the shear web 16 when the web is installed via the gantry.

In some embodiments, the walking path 93 can be a mobile elevating work platform or mechanical platform equipped with hydraulic cylinders that extend and retract to raise and lower the walking path 93. In some embodiments, the height of the walking path 93 can be adjusted by an operator on the platform and using a control system. In yet other embodiments, the height of the walking path 93 can be adjusted remotely by an operator.

In some embodiments, the wiring 96 can include a cable retractor. A cable retractor can manage the wiring and retract excess cable as the carrying cart 5 moves around the wind turbine blade shell.

In some embodiments, the holding element 95 (i.e., thermal isolation layer 1, composite panel for curing area 2, copper tape 3a and carbon coating 3, a protection layer 4) can include temperature control devices such as temperature sensors to monitor and regulate temperature throughout operation.

Referring now to FIG. 10A, an illustration of a view of an exemplary device for heating a composite segment of a wind turbine blade is shown including a holding element 95 including the thermal isolation layer 1, a composite panel for curing area 2, a copper tape 3a (not shown) and carbon coating 3, a protection layer 4, load-carrying struts 91 of the shear web gantry, an electrical box 6, a toroidal transformer and controller 7, a wind turbine blade shell 12a,b, a shear web 16, a bonding paste 92, a walking path 93, a carrying cart 5, wiring 96, and a mold 10 of a wind turbine blade shell 12a,b, and vertical supporting members 97a,b.

Referring again to FIG. 10A and in greater detail, the holding element 95 (i.e., thermal isolation layer 1, composite panel for curing area 2, copper tape 3a and carbon coating 3, a protection layer 4) can be substantially rectangular in shape and sized to fit between flanges 20,99 along the bottom of the shear web 16. The upper surface of the holding element 95 can be sized so that it contacts the lower (or internal) surface of upper flange 99. Likewise the lower surface of the holding element 95 can be sized so that it contacts the upper (or internal) surface of lower flange 20. In some embodiments, heat is only generated on the lower surface of the holding element 95, so that the heat generated is focused or directed downwardly through the lower flange 20 and into the paste 92 (and further into the blade shell 12a,b if so desired).

In some embodiments, the holding element 95 is sized to extend laterally outward beyond the width 98 of the flange 20. In some embodiments, the holding element 95 is disposed above the flange 20, such that the holding element does not contact the B-surface (i.e., interior surface 17 of the wind turbine shell 12a,b). This allows for heat to be directed and delivered only to the shear web flange 20 (and the adhesive and spar cap disposed thereunder), which can be advantageous at certain locations along the blade span (e.g. proximate the blade root where the thickness of the components may increase). This allows for controlled heating either by adjusting (higher or lower) the temperature of select local heating elements 95 at specific locations, and/or adjusting the dwell time for select local heating elements to ensure the desired amount of curing is achieved for the given locations needs (thickness, paste amount, etc.).

For purpose of illustration and not limitation, a schematic rendering of an exemplary holding element 95 is shown in FIG. 10A wherein the holding element 95 only contacts the shear web (i.e. there is no direct physical contact between the B-surface of the blade shell 12a,b and the holding element 95). Here, the holding element is coupled to a strut 91 of the gantry (an upper portion of the strut 91, not shown in this view for clarity sake, can be releasably coupled to the shear web 18, to carry the weight of the shear web, at a location above the holding element 95). The holding element 95 can be removably coupled to the gantry strut 91 (so that it can be serviced and/or relocated to another strut along the blade span). Additionally or alternatively, the struts themselves can be repositioned (e.g. slid along the gantry to increase the number of struts proximate the root to support the heavier components at that location). The holding element 95 can also be articulated (e.g. rotated to adjust the pitch relative to the shear web flange 20) to maximize the amount of surface area of the holding element 95 in contact with the shear web flange 20.

In some embodiments, the width of the holding element is the width 98 of the flange 20. There can be a plurality of holding elements shaped and sized to cover regions of the flange 20 of the shear web 16. In some embodiments, the plurality of holding elements 95 are contiguous along the entire longitudinal length of the shear web 16. In some embodiments, the plurality of holding elements 95 are evenly spaced apart along the longitudinal length of the shear web 16. In some embodiments, the plurality of holding elements 95 are unevenly spaced apart along the longitudinal length of the shear web 16. The distance between holding elements can depend on the distinct zones or areas where ‘targeted heating’ is desired and/or to optimize curing time. Holding elements can be placed at locations critical for curing time. In some embodiments, the plurality of holding elements can differ from each other in size. The size of the holding elements can depend on the location along the longitudinal length of the shear web 16 and depend on the width 98 of the flange 20. The locations of the holding elements can depend on the weight distribution of the shear web.

In some embodiments, the wiring 96 forming an electrical connection between the electrical box 6 and the heating elements (i.e., copper tape 3a and carbon coating 3) of the holding element can be arranged such that the heating of each of the plurality of holding elements is controlled individually. Additionally or alternatively, the wiring 96 forming an electrical connection between the electrical box 6 and the heating elements of the holding element 95 can be arranged such that the heating of each of the plurality of holding elements is controlled uniformly among the plurality of holding elements.

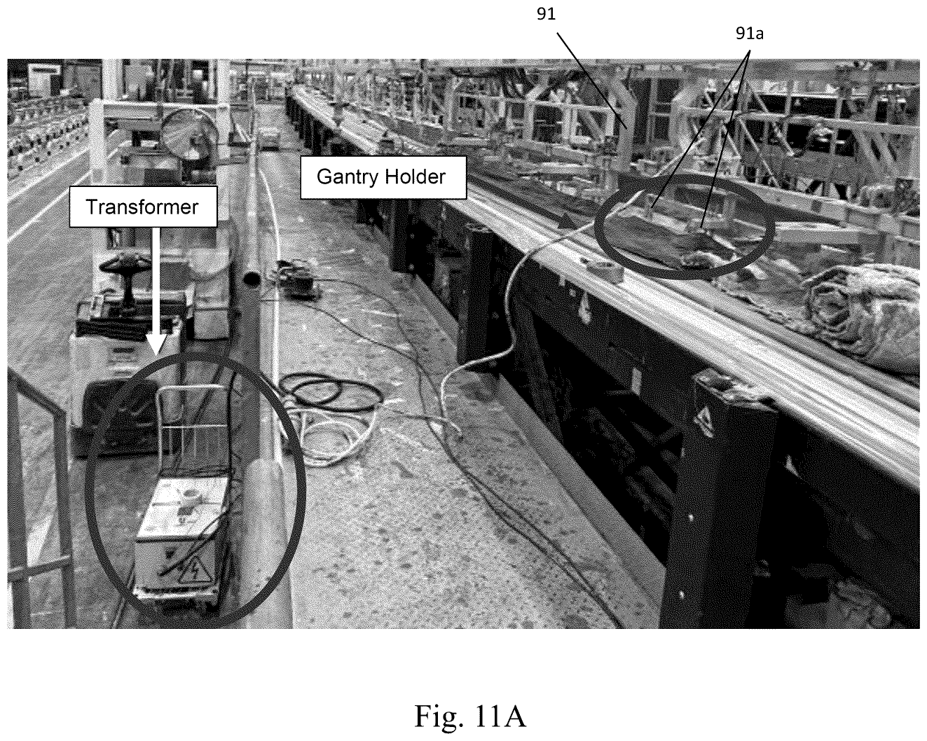

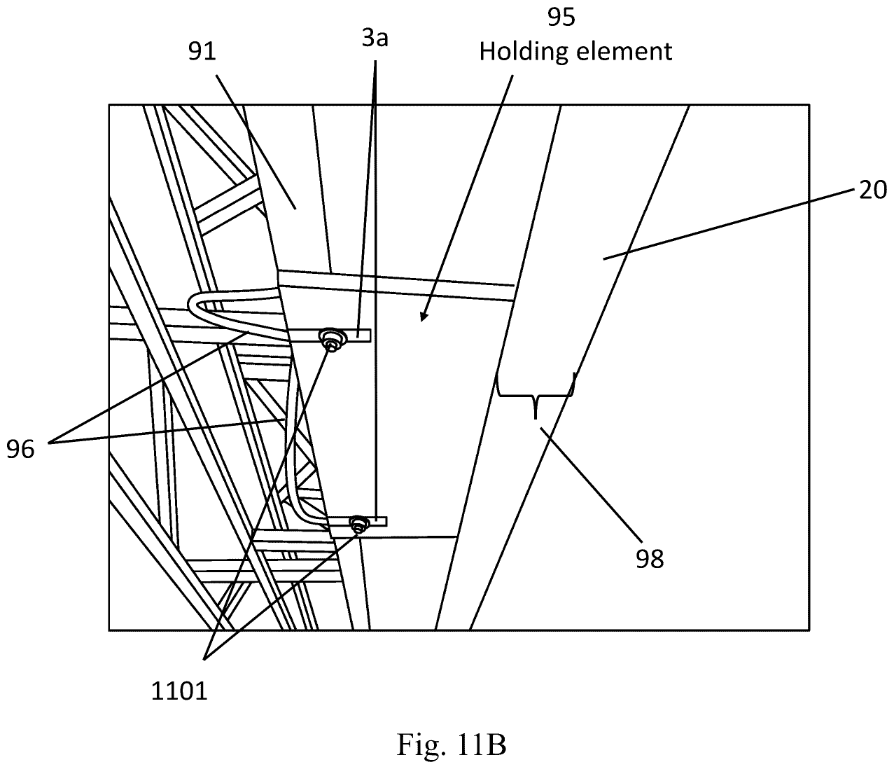

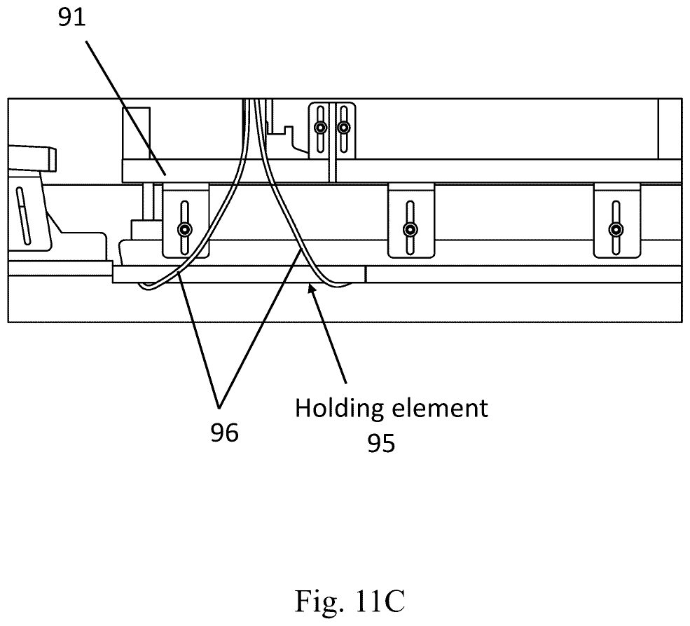

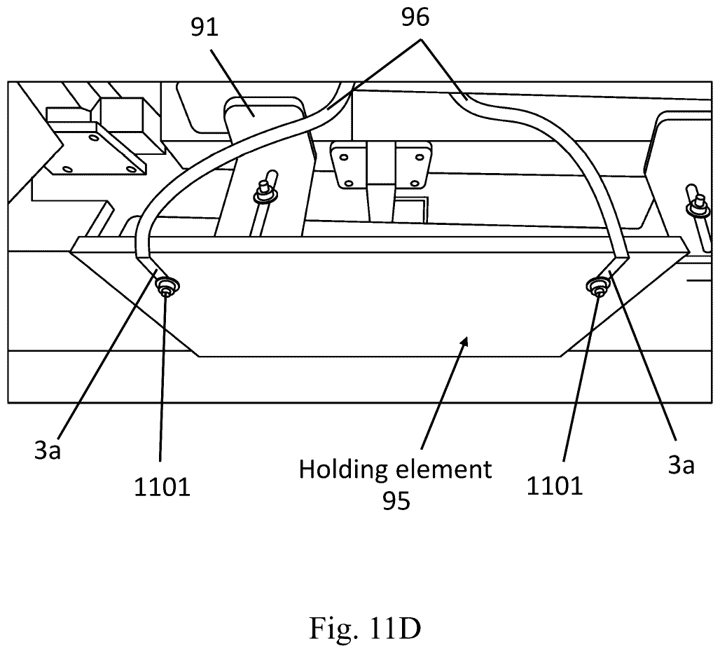

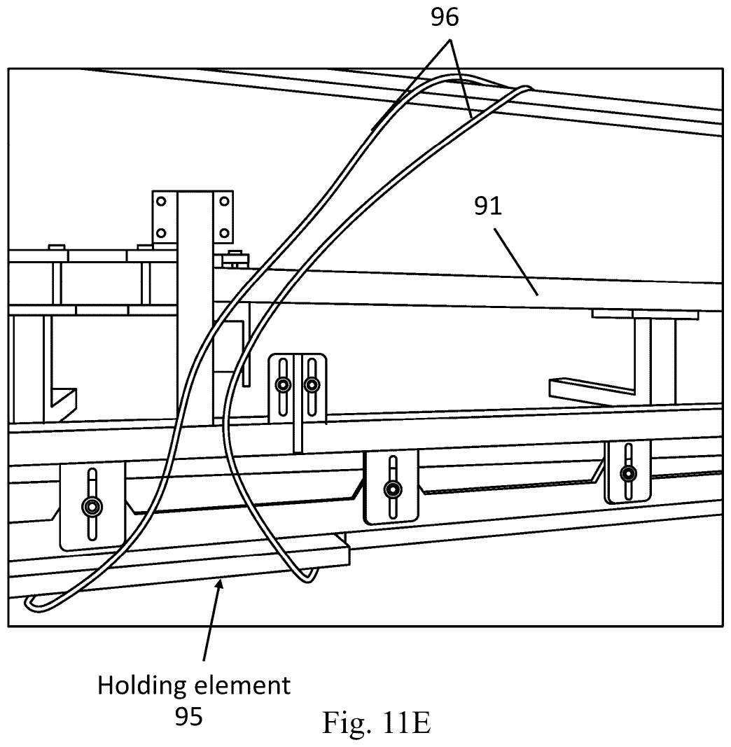

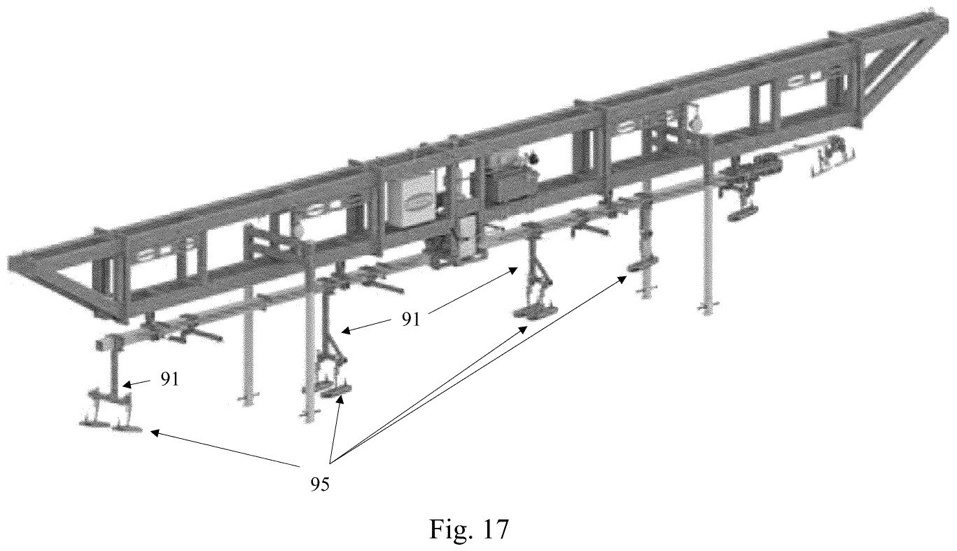

Referring now to FIG. 11A, the load-carrying struts 91 of the shear web gantry consists of a rigid frame of bar members and further comprises a plurality of gantry holders 91a. The bars forming the frame can be joined together by a singular coupling mechanism or a combination of coupling mechanisms including welding, fastening with bolts, screws, or clamps. The load-carrying struts 91 of the shear web gantry can be a commercially available rig capable of lifting and positioning loads (e.g., equipment used in blade manufacturing to move components into place). The plurality of gantry holders 91a are attached to the load-carrying struts 91 of the shear web gantry and are manufactured to exact dimensions to attach to a holding element 95 at two attachment points using nuts and bolts. The shear web 16 is secured to the load-carrying struts 91 of the shear web gantry and remains secured throughout the curing process to ensure stability and fixed positioning of the shear web 16. An exemplary gantry for carrying a shear web 16 (omitted for clarity) is depicted in FIG. 17, with the location of holding elements 95 of the present disclosure depicted at the ends or “feet” of the gantry attachment points to engage the shear web flange(s) as described herein. As described above, the number and location of the gantry arms can be adjusted to accommodate a variety of shear web designs (e.g. I-beam, V-shape, etc.) and weight distribution (e.g. thicker/taller/heavier near the blade root than at the blade tip).

The load-carrying struts 91 of the shear web gantry is used to lift and position the shear web 16 (with the holding element placed between the flanges 20,99 of the shear web 16) into the wind turbine blade shell 12a,b. The bonding paste 92 can be disposed on the bottom of the shear web 16 and then brought into contact with the interior surface 17 of the wind turbine blade shell 12a,b. In some embodiments, the bonding paste 92 can be disposed on the interior surface 17 of the wind turbine blade shell 12a,b and then brought into contact with the bottom of the shear web 16. The shear web 16 (with the holding element placed between the flanges 20,99 of the shear web 16) are secured to the load-carrying struts 91 of the shear web gantry and remain secured throughout the curing process to ensure stability and fixed positioning of the shear web 16. The electrical connections including the wiring 96 can be added following the positioning of the shear web 16 (with the holding element placed between the flanges 20,99 of the shear web 16) on the interior surface 17 of the wind turbine blade shell 12a,b. In some embodiments, the holding element placed between the flanges 20,99 of the shear web 16 is only on one side of the shear web 16 (e.g., as shown in FIGS. 9A-C and 10A). Heating the flanges on one side of the shear web 16 can be sufficient to cure the underlying layer of bonding paste 92. In some embodiments, the holding element 95 is placed between the flanges 20,99 of the shear web 16 on both sides of the shear web 16 and heating of both sides of the web occurs in parallel.

Following placement of the load-carrying struts 91 of the shear web gantry (with shear web 16 and holding element placed between the flanges 20,99 of the shear web 16) on the interior surface 17 of the wind turbine blade shell 12a,b and proper placement of electrical connections including wiring 96, the voltage supplied to the heating elements of the holding element (i.e., thermal isolation layer 1, composite panel for curing area 2, copper tape and carbon coating 3, a protection layer 4) is increased and the temperature of the heating elements increases to heat the flange 20 and the underlying bonding paste 92. When the shear web 99 is sufficiently bonded to the wind turbine shell 98, the gantry holder system is removed from the wind turbine shell 98 (the holding element 95 can be detached and removed in advance of the gantry, or remain attached to the gantry and removed simultaneously therewith).

Referring now to FIGS. 11B-E, views of the holding element 95 (i.e., thermal isolation layer 1, composite panel for curing area 2, copper tape 3a and carbon coating 3, a protection layer 4) and the bottom of a flange of a shear web 16 attached to the load-carrying struts 91 of the shear web gantry are shown. The wiring 96 connected to an external power supply (e.g, electrical box 6, electrical box 6 with toroidal transformer and controller 7) makes an electrical connection at connection points 1101 on the bottom of the holding element. The attachments points are the locations where the copper strips 3a are exposed. While the external power supply can be attached directly, and only, to the copper strips 3a, once current is applied through the strips 3a the current is also transmitted/flows through the carbon paint layer 3. In some embodiments, the carbon paint layer 3 is directly above and in contact with the flange 20. In some embodiments, the protection layer 4 separates the carbon paint layer 3 from being in direct contact with the flange 20. In those embodiments, the protection layer 4 is directly above and in contact with the flange 20. The heating paint (e.g., carbon paint layer 3) should be as close as possible to the curing area to reduce the thickness of the layers that heat must be conducted through to heat and bond the flange 20 and underlying bonding paste 92. As shown in the exemplary embodiment of FIG. 11B, the holding element 95 can extend laterally (e.g. towards the blade leading or trailing edge) beyond the boundary of the shear web (indicated by reference numeral 98). In such embodiments heat can be applied to both the flange (and underlying paste and spar cap) as well as the surrounding shell surface 12a,b.

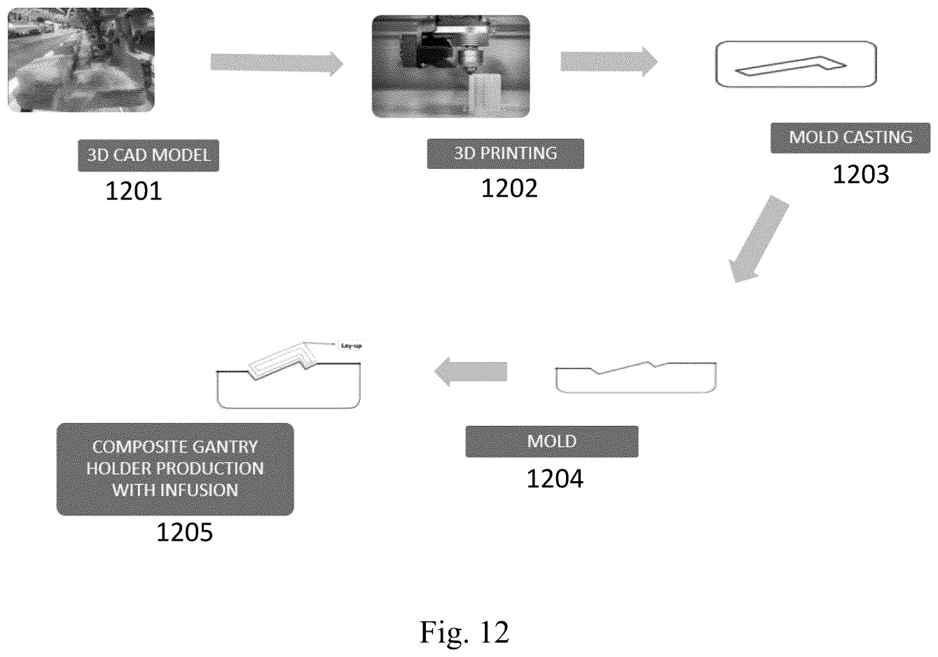

Referring now to FIG. 12, illustrates a diagram of the manufacturing process for a composite gantry holder 91a. The gantry holder 91a can be manufactured with exact dimensions using a 3D printer. A 3D CAD model 1201 of the mold shape of a composite gantry holder 91a is created. The CAD model is then printed using 3D printing 1202 to make the mold composite gantry holder. Following printing, mold casting 1203 is performed. The mold is made by casting the metal mold frame onto the 3D printed part. The mold 1204 is then separated from the 3D printed part. Following separation of the mold and 3D printed part, the final step in manufacturing is the composite gantry holder production with infusion 1205. Mats of fibers including materials such as glass carbon or aramid are deposited to form layers of fiber. Fibers are infused with resin to make the composite gantry holder 91a.

Sufficient bonding can be determined by measuring the hardness of the bonding paste and a specified threshold value of hardness can be used to determine when the gantry holder system is removed. A penetrometer can be used to measure the measure the stiffness of the bonding paste. In some embodiments, an operator can manually measure the stiffness of the bonding paste using a penetrometer. In those embodiments, an operator can manually measure the stiffness of the bonding paste at one or more locations along the flange of the shear web. In some embodiments, the stiffness of the bonding paste can be measured every 100 mm. Because of the heterogeneity associated with the curing process, the stiffness is measured throughout operation and at a plurality of locations where the bonding paste is disposed. The curing process can also be heterogenous due to varying amounts of bonding paste at different zones or areas. The operator can adjust the voltage supplied to the heating elements in the holding elements to vary the heating and temperature depending on the stiffness measurements. In some embodiments, the stiffness of the bonding paste may be measured using sensors configured to measure stiffness. In those embodiments, the sensors configured to measure stiffness can be integrated with the gantry holder system. In some embodiments, the stiffness measurements taken by sensors can automatically control the heating of the heating elements. Alternatively or additionally, a threshold temperature of the bonding paste can be used to determine when the gantry holder system is removed from the wind turbine shell (e.g., a predetermined temperature defining a full cure of the bonding paste). In some embodiments, a temperature probe or sensor can be used to measure the bonding paste. In some embodiments, the temperature probe or sensor can be coupled to the holding element to monitor the temperature throughout curing time. In some embodiments, an operator can manually check the temperature of the bonding paste with a temperature measuring instrument.

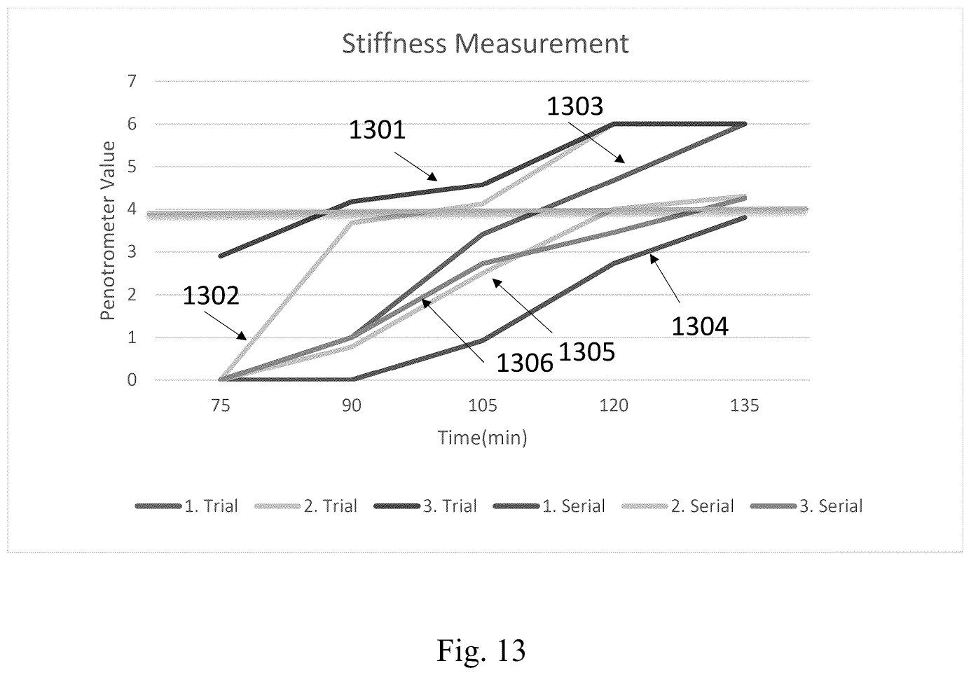

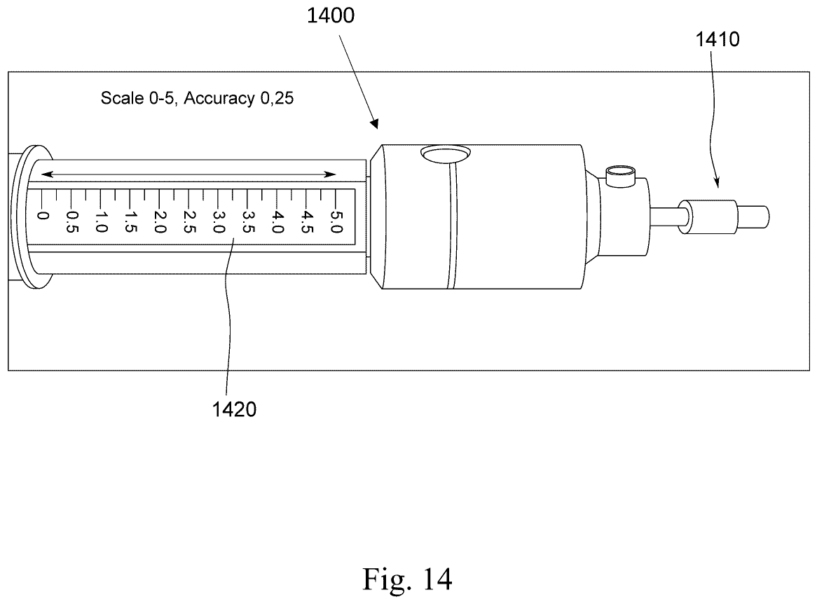

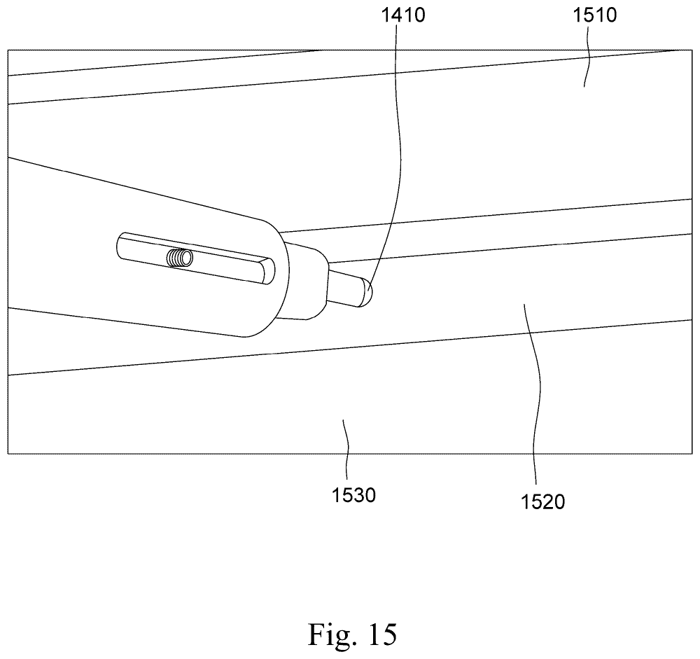

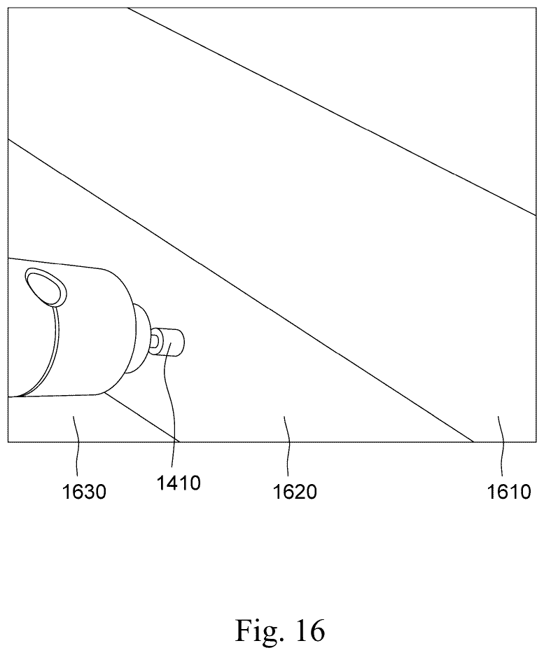

Referring now to FIG. 13, a graph of stiffness measurements of heated bonding paste between a shear web and a wind turbine shell as a function of time is shown. The stiffness measurements were taken with a penetrometer instrument shown in FIG. 14. The instrument measures the resistance of a material to penetration or deformation. The penetrometer 1400 has a probe 1410 that is pressed into a material with a known force, and the depth of penetration or the force required is measured. The penetrometer measurement is unitless. Lower penetration values on the scale 1420 of the penetrometer indicate a higher stiffness, while higher penetration values indicate a higher stiffness or higher consistency. Prior to measurements, the penetrometer was evaluated and calibrated. The appropriate probe such as a needle or cone was attached to the penetrometer depending on the material being tested. To perform tests, the sample surface was made flat and level. The penetrometer was positioned vertically above the sample. An illustration of a penetrometer measurement of heated adhesive is shown in FIG. 15. The penetrometer probe 1410 was lowered slowly and steadily onto adhesive 1520 lining the area between the surfaces 1510, 1530 until it reached a specified depth or resistance and the corresponding penetration value was taken. By comparison, a penetrometer measurement of adhesive without heating paint, as illustrated in FIG. 16, shows that adhesive 1620 lining the area between the surfaces 1610, 1630 is not hardened after 105 minutes. Without heating paint, the curing time to bond surfaces with adhesive was a total of 135 minutes. With heating paint, the curing time to bond surfaces with adhesive was a total of 105 minutes.

Referring again to FIG. 13, several trials 1301, 1302, 1303 and serial trials 1304, 1305, 1306 were conducted to measure the stiffness of heated adhesive using a penetrometer as a function of time. Multiple measurements were taken with the same penetrometer at different locations on the sample and averaged. A gantry holder system produced using infused composite materials and coupled with the holding element embedded with the heating elements was installed. The transformer supplying 48 volts to the gantry holder system was placed underneath the walking path and cables were routed from underneath the walking path to establish electrical connections to the gantry holder system. Penetrometer measurements were taken at 15-minute intervals between the 75^{th} and 135^{th} minute comprising 3 trials and 3 productions runs for each time interval. A total of 10 measurements were taken using a penetrometer from heated and non-heated areas of the sample. The stiffness measurements are also summarized in Table 1. Sample temperature was measured in addition to stiffness measurements at two time intervals including the 90^{th} and 135^{th} minute.

The curing data provides the transition from the amorphous phase to the crystalline phase of the chemical. The glass transition temperature is obtained through measurements with a Differential Scanning calorimetry device using thermodynamic laws. When the chemical glass transition temperature curve begins to emerge, this indicates that the curing process has reached a certain degree in the structure. The crystalline phase has a more ordered and dense atomic structure which leads to an increase in hardness value. Table 2 shows that a penetration value of 4 corresponds with the glass transition temperature of the epoxy adhesive used. As a result, a penetration value of 4 was determined as the hardness value at which the gantry holder system and holding element can be removed. The trial results show that with the gantry holder system and holding elements embedded with heating elements, a hardness value of 4 can be achieved in 30 minutes.

TABLE 1
Stiffness measurements taken at five time intervals

| | No/Time(min) | | | | |
|---|---|---|---|---|---|
| | 75 | 90 | 105 | 120 | 135 |
| 1. Trial | 0.0 | 1.0 | 3.4 | 4.7 | 6.0 |
| 2. Trial | 0.0 | 3.7 | 4.1 | 6.0 | 6.0 |
| 3. Trial | 2.9 | 4.2 | 4.6 | 6.0 | 6.0 |
| 1. Serial | 0.0 | 0.0 | 0.9 | 2.7 | 3.8 |
| 2. Serial | 0.0 | 0.8 | 2.5 | 4.0 | 4.3 |
| 3. Serial | 0.0 | 1.0 | 2.7 | 3.5 | 4.3 |

TABLE 2
Stiffness and temperature measurements taken at two time intervals

| | No/Time(min) | | | |
|---|---|---|---|---|
| | 90 | | 135 | |
| Measurement | Tg(° C.) | Stiffness | Tg(° C.) | Stiffness |
| 1. Trial | 50.1 | 1.0 | 55.1 | 6.0 |
| 2. Trial | 69.7 | 3.7 | 74.9 | 6.0 |
| 3. Trial | 54 | 4.2 | 62.6 | 6.0 |
| 1. Serial | NA | 0.0 | 45.6 | 3.8 |
| 2. Serial | NA | 0.8 | NA | 4.3 |
| 3. Serial | NA | 1.0 | 48.9 | 4.3 |

In accordance with an aspect of the present disclosure, the system disclosed herein provides the following advantages:
An alternative heating source instead of electrical wiring and heated air.
Avoids or minimizes mold maintenance and cable malfunction. This prevents mold repairs which can result in micro cracks and internal air leaks.
Applies heating paint on top of substrates with a covering layer to molds and reinforcement areas.
Special coating (e.g. carbon paint) which activates with electricity which is distributing homogeneous heating on every location of substrate.
The resistance depends on the thickness of the implemented coat. The current flow depending on the resistance and the voltage.
Provides energy savings and improved safety (e.g., no wiring faults or trip hazards).
Transformers ensure the heater receives sufficient power.
System is maintenance free.
System has homogenous temperature, and it can be traceable with Wi-Fi system.

The heatable coating 3 disclosed herein can include conductive nanomaterial. In certain aspects, such a coating, when heated resistively by the application of an electric current provided via strips 3a (and which can be delivered via AC or DC), heats an item or surface to which it has been applied. In some embodiments, an event sensor is incorporated into the system (e.g. coupled to the composite panel) which senses an event related to the item with the coating. For example, the sensed event may be a temperature threshold, or a change in temperature. Upon such sensing occurring, the electrical system can adjust the current in strips 3a to increase/reduce the temperature of the coating 3.

Accordingly, the composite panel heating system disclosed herein not only accelerates the production process but also improves the quality of the demolded blades by better distributing the heat across the thickness of the part and ensuring the proper degree of cure throughout the blade. Additionally the present disclosure reduces the cure process time; avoids/minimizes non-uniform degree of cure in the blade; provides controlled B-surface temperature; and monitors/avoids glass transition temperature (Tg) criteria violation. Furthermore, the present disclosure reduces overall cycle time by reducing delay in mold closure step (i.e. where the first mold half is inverted on top of the second mold half to form a complete, closed, blade) by reducing the hot surfaces (e.g. spar cap).

The present disclosure is applicable to a variety of blade designs, including ones with shear web(s) and corresponding spar caps. The upper and lower mold skins can also include a core material, e.g. having an increasing thickness from the midpoint to trailing edge of the blade.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus for heating a composite product comprising:
a thermal isolation layer, the thermal isolation layer having a pair of opposing sides, and a top surface and bottom surface defining a thickness therebetween;
a composite panel, the composite panel having a pair of opposing sides, and a top surface and bottom surface defining a thickness therebetween;
a first conductive strip, the first conductive strip having a pair of opposing sides, and a top surface and bottom surface defining a thickness therebetween;
a second conductive strip, the second conductive strip having a pair of opposing sides, and a top surface and bottom surface defining a thickness therebetween;
the first and second conductive strips spaced apart by a first distance;
at least one layer of conductive paint, the at least one layer of conductive paint disposed over the first and second conductive strips;
a protection layer, the protection layer having a pair of opposing sides, and a top surface and bottom surface defining a thickness therebetween.

2. The apparatus of claim 1, wherein the composite product is a wind turbine blade.

3. The apparatus of claim 1, wherein the first and second conductive strips are composed of copper tape.

4. The apparatus of claim 1, wherein the at least one layer of conductive paint includes a copper paint.

5. The apparatus of claim 1, wherein the composite panel is disposed on the top surface of the thermal isolation layer.

6. The apparatus of claim 1, wherein the first and second conductive strips disposed on the top surface of the composite panel.

7. The apparatus of claim 1, wherein the at least one layer of conductive paint is disposed on the top surface of the first and second conductive strips.

8. The apparatus of claim 1, wherein the protection layer is disposed on a top surface of the at least one layer of conductive paint.

9. The apparatus of claim 1, wherein the first and second conductive strips are configured in a parallel configuration.

10. The apparatus of claim 1, further comprising a cart including a power source, the cart configured to transport the thermal isolation layer, composite panel, first and second conductive strips, at least one layer of conductive paint and the protection layer along an exterior of a wind turbine blade.

11. A method for heating a portion of a wind turbine blade comprising:
providing at least a portion of a wind turbine shell within a mold;
providing at least one shear web, the shear web having an upper and lower flange;
positioning the at least one shear web within the wind turbine shell;
positioning a holding element proximate the shear web, the holding element having a pair of opposing sides, and a top surface and bottom surface defining a thickness therebetween including:
a thermal isolation layer,
a conductive strip,
a layer of conductive paint, the layer of conductive paint disposed over the conductive strip,
a protection layer; and
applying heat to the lower flange of the shear web.

12. The method of claim 11, wherein positioning the at least one shear web within the wind turbine shell includes lifting the shear web with a gantry.

13. The method of claim 12, wherein the holding element is coupled to the gantry.

14. The method of claim 12, wherein the holding element is releasably coupled to the gantry.

15. The method of claim 11, wherein the lower flange includes a first flange and a second flange, the first and second flanges spaced to define a channel therebetween.

16. The method of claim 15, wherein the holding element is at least partially disposed within the channel.

17. The method of claim 16, wherein the top surface of the holding element contacts a bottom surface of the first flange, and a bottom surface of the holding element contacts a top surface of the second flange.

18. The method of claim 11, wherein a first side of the holding element extends laterally beyond an edge of the lower flange.

19. The method of claim 11, further comprising applying adhesive between the lower flange of the shear web and the turbine shell.

20. The method of claim 19, further comprising measuring the hardness of the adhesive after the heating step.
